(19) United States
(12) Patent Application Publication
(10) Pub. No.: US 2021/0349177 A1
(43) Pub. Date: Nov. 11, 2021

(54) LOW PROFILE POINTING DEVICE

(71) Applicant: 7hugs Labs SAS, Montrouge (FR)

(72) Inventors: Julien Colafrancesco, Paris (FR); Nicolas Schodet, Antony (FR); Simon Tchedikian, Issy-les-moulineaux (FR)

(73) Assignee: 7hugs Labs SAS, Montrouge (FR)

(21) Appl. No.: 17/135,754

(22) Filed: Dec. 28, 2020

Related U.S. Application Data
(60) Provisional application No. 63/022,065, filed on May 8, 2020.

(51) Int. Cl. G01S 5/06; H01Q 3/36; G01S 5/02

(52) U.S. Cl. CPC G01S 5/06; G01S 5/0205; H01Q 3/36

(57) ABSTRACT

Methods and systems related to the field of pointing devices are disclosed herein. A pointing device having a pointing direction can include at least two antennas aligned with the pointing direction. A pointing target can include at least one antenna that can transmit a signal to be received by the at least two antennas in the pointing device. A difference of the signal as received by each of the at least two antennas in the pointing device can be determined. An angle between the pointing direction and the pointing target can be determined using the difference.

### CROSS REFERENCE TO RELATED APPLICATIONS

The application claims the benefit of U.S. Provisional Patent Application No. 63/022,065, filed May 8, 2020, which is incorporated by reference herein in its entirety for all purposes.

### BACKGROUND

Pointing devices are largely used for a wide variety of applications. The accurate determination of the pointing direction of this kind of devices plays an important role in their overall performance and practical applicability. In order to determine the pointing direction, for example with respect to a certain target such as a screen, it would be necessary to locate the position and the orientation of the pointing device with respect to the target, or vice versa. The position and orientation, collectively referred to as the pose, represent a set of six variables. The determination of each of those variables could involve a large number of sensors and considerable processing power. It is expensive and complex to fit enough sensors in a portable device, especially for devices with a small form factor, which is typically the case of pointing devices.

### SUMMARY

Methods and systems related to the field of pointing devices are disclosed herein. Systems in accordance with specific embodiments of the invention can include various devices. In the present disclosure, a device that points to another device, object or surface will be referred to as a pointing device, and a device, object or surface that is pointed at by a pointing device will be referred to as a pointing target.

Pointing devices in accordance with specific embodiments of the invention can be used to interact with pointing targets by using a determination of the position and/or the orientation of the device with respect to the pointing target. The pointing device can be a portable device. The pointing target can be a fixed pointing target, such as a fixed surface, screen or display. The pointing target can be a remote pointing target, such as a remote surface, screen or display.

In specific embodiments of the invention, a pointing device can interact with a pointing target. In specific embodiments of the invention, the pointing direction of the pointing device can be determined, for example, with respect to the pointing target. In specific embodiments of the invention, by determining the pointing direction of the pointing device, an interaction with the pointing target around the point of intersection of the pointing direction imaginary line with the pointing target can be possible.

In accordance with specific embodiments of the invention, a condition for interaction between a pointing device and a pointing target can be determined by providing a set of antennas in the system. For example, a set of at least two antennas can be provided associated with the pointing device. At least two antennas in the set of antennas can be aligned with the pointing direction of the device. In specific embodiments of the invention, the set of antennas associated with the pointing device can receive a signal and, by determining the phase difference of the signal as received by the antennas in the set of antennas associated with the pointing device, it can be possible to determine an angle between the pointing direction and the source direction of the signal. This angle can be referred to as a pointing angle. This angle can indicate the pointing direction of the pointing device.

In specific embodiments of the invention, the pointing target can be associated with at least one antenna. The source of the signal received by the at least two antennas associated with the pointing device can be the at least one antenna associated with the pointing target. In those embodiments, it can be possible to determine the angle between the pointing direction and the line between the pointing device and the pointing target. In specific embodiments of the invention, this angle is a pointing angle. In those embodiments, this angle can indicate the pointing direction of the pointing device with respect to the pointing target.

In specific embodiments of the invention, at least a pair of antennas is associated with the pointing device on one hand, and at least one antenna is associated with the pointing target on the other hand. In specific embodiments of the invention, the distribution of antennas in the system allows a determination of geometric parameters based on localization techniques, such as angle-of-arrival (AOA).

In specific embodiments of the invention, the placement of at least two antennas in the pointing device can offer several advantages to the system. For example, in specific embodiments of the invention, real-time interaction between a pointing device and a pointing target can be achieved at a lower cost than conventional technologies. Additionally, in specific embodiments of the invention, real-time interaction between a pointing device and a pointing target can be achieved while involving fewer sensors than conventional technologies. As another example, in specific embodiments of the invention, a condition for interaction can be determined without needing to solve the set of six variables for the pose of the pointing device.

In specific embodiments of the invention, a device is provided. The device can comprise a pointing direction. The device can also comprise a set of antennas including a first antenna and a second antenna. The first antenna and the second antenna can be aligned with the pointing direction. The device can also comprise one or more computer readable media storing instructions which, when executed on the device, can cause the device to: determine a difference between a signal as received by the first antenna the signal as received by the second antenna; and determine, using the difference, an angle between the pointing direction and a signal source direction of the signal. The difference can be a difference between the phase of the signal as received on the two antennas, a difference in the time of arrival of the signal on the two antennas, a difference in the amplitude of the signal as received on the two antennas, a difference in the shape of the signal as received on the two antennas, and a difference in the frequency content of the signal as received on the two antennas.

In specific embodiments of the invention, a system is provided. The system can comprise a portable device having a pointing direction and a set of antennas including a first antenna and a second antenna, wherein the set of antennas is aligned with the pointing direction. The system can also comprise a third antenna associated with a pointing target. The system can also comprise one or more computer readable media storing instructions which, when executed by the system, can cause the system to: transmit a signal using the third antenna; determine a difference between a first phase of the signal as received by the first antenna and a second phase of the signal as received by the second antenna; and determine, using the difference, an angle between the pointing direction and a line between the pointing target and the portable device.

In specific embodiments of the invention, a method is provided. Each step of the method can be computer-implemented. The method can comprise obtaining a first sample of a signal on a first antenna and a second sample of the signal on a second antenna, wherein the first antenna and the second antennas are in a set of antennas on a portable device, and wherein the set of antennas are aligned with a pointing direction of the portable device. The method can also comprise determining, using the first sample and the second sample, a difference between a first phase of the signal as received by the first antenna and a second phase of the signal as received by the second antenna. The method can also comprise determining, using the difference, an angle between the pointing direction and a line between a target point and the portable device.

### BRIEF DESCRIPTION OF THE DRAWINGS

FIG. 1 includes an example of a 3D environment where a pointing device and a pointing target can be used in accordance with specific embodiments of the invention disclosed herein.

FIG. 2 includes an example of the coordinates system relative to the portable device and selection cone in accordance with specific embodiments of the invention disclosed herein.

FIG. 3 includes an example of the pointing device in a deselected pose in accordance with specific embodiments of the invention disclosed herein.

FIG. 4 includes a front view, a side view, and a top view of a scenario where a user is standing in a deselected pose in accordance with specific embodiments of the invention disclosed herein.

FIG. 5 includes a front view, a side view, and a top view of a scenario where a user is sitting in a deselected pose in accordance with specific embodiments of the invention disclosed herein.

FIG. 6 includes an antenna configuration for the pointing device in accordance with specific embodiments of the invention disclosed herein.

FIG. 7 includes an example of a two-dimensional representation of a plurality of possible locations and orientations of the pointing device in accordance with specific embodiments of the invention disclosed herein.

FIG. 8 includes an example of a system for angle-of-arrival measurement in a two aligned antenna configuration in accordance with specific embodiments of the invention disclosed herein.

FIG. 9 includes an example of the relationship between angle-of-arrival, pointing direction and position of the pointing device in accordance with specific embodiments of the invention disclosed herein.

FIG. 10 includes an example of the spherical coordinate system and cartesian coordinate system of the pointing device in accordance with specific embodiments of the invention disclosed herein.

FIG. 11 includes an illustration of the yaw, pitch and roll angles that can be associated with the three axes x, y and z in accordance with specific embodiments of the invention disclosed herein.

FIG. 12 includes a flow chart for a pipeline of a Kalman filter in accordance with specific embodiments of the invention disclosed herein.

FIG. 13 includes different antenna configurations for a pointing device in accordance with specific embodiments of the invention disclosed herein.

FIG. 14 includes possible configuration for a pointing device comprising three antennas in accordance with specific embodiments of the invention disclosed herein.

FIG. 15 includes possible configurations for a pointing target comprising two antennas in accordance with specific embodiments of the invention disclosed herein.

FIG. 16 includes an example of system comprising an array of antennas in accordance with specific embodiments of the invention disclosed herein.

### DETAILED DESCRIPTION

Methods and systems related to the field of pointing devices in accordance with the summary above are disclosed in detail herein. The methods and systems disclosed in this section are nonlimiting embodiments of the invention, are provided for explanatory purposes only, and should not be used to constrict the full scope of the invention.

The following patents and patent applications from the same applicant are incorporated by reference herein in their entirety for all purposes: European Patent No. EP3172727B1 entitled “Methods for determining and controlling a piece of equipment to be controlled, and device, use and system implementing said methods”; U.S. patent application Ser. No. 16/049,074 entitled “System for Object Tracking in Physical Space with Aligned Reference Frames” by Julien Colafrancesco, Simon Tchedikian, Nicolas Schodet and Simon Guillot filed on Jul. 30, 2018; and U.S. patent application Ser. No. 16/056,888 entitled “Polarization Axis Attenuation and Cross Polarization Resistant Antenna Orientation Assembly for Tracked Object” by Julien Colafrancesco and Oliver Mandine filed on Aug. 7, 2018.

Pointing devices in accordance with specific embodiments of the invention can be used to interact with pointing targets. The pointing device can be any device that can point to a pointing target. The pointing device can be a portable device. The pointing device can be used to point at a pointing target, such as a remote screen, in a way that is analogous to a laser diode pointing on a screen. The pointing device can be capable of receiving and/or transmitting radio-frequency signals such as ultra-wide band (UWB) signals.

The pointing device can comprise a main pointing direction. In specific embodiments of the invention, the pointing direction is physically delineated by the device. For instance, the pointing device may include a housing with a longitudinal direction extending more than the other directions, indicative of the main pointing direction. In this way, the pointing device can have a shape that defines a natural pointing direction of the pointing device. For example, the device could be a rectangle with a distinguished short edge where the long side of the rectangle and distinguishing features of that short edge naturally indicated the pointing direction of the object. The pointing direction of the pointing device can be associated with a heading the user aligns a target with when pointing. The pointing device could be configured to transmit signals intended for a pointing target aligned with the pointing direction in order to fulfill its main functionality. The signals may be transmitted omnidirectionally or using a directed transmission using beamforming to send a narrow signal in the pointing direction.

The pointing device can be any object, such as a smartphone, a personal user device generally, a remote control, a presentation pointer, a telepointer, an inventory management device, a drone or a toy. The pointing device could be of any shape, such as a disc, with a pointing direction indicated by an arrow icon on the surface of the device. In other examples, any indicator which allowed a person to determine which way to point a device could be considered as providing the device with a pointing direction as that term is used herein.

The pointing device could be a handheld device, such as a remote control, a smart remote, an air mouse, a game controller, a wand, a cellular telephone, a smartphone, a tablet device, an electronic car key, a digital camera, or flashlight, and the like. The pointing device could be a wearable device wherein the main pointing direction can be the line of sight of the user wearing the wearable device, such as an earpiece device, a headphone device, wireless earbuds, or a virtual/augmented reality headset. The pointing device could be any other wearable device having a natural pointing direction, such as a wrist-watch device (pointing direction can be forearm) or a pendant device (pointing direction can be the line of sight of the user) for instance.

A pointing target can be any surface, device or object that the pointing device can point to. The pointing target could be a remote pointing target. The pointing target could be a physical surface like a wall, or virtual surface, a screen, a display, etc. The pointing target could be a remote screen. The remote screen could be a fixed screen, such as a home theater screen, a TV screen, a computer monitor, a surface on a wall, a virtual surface, an array of LED lights, a surface mounted display, a digital photo frame, an array of flat panel displays, and the like. Specific examples throughout this disclosure use a remote fixed screen as a possible pointing target. However, the concepts described herein are not limited to that specific kind of pointing target. For example, the same concepts described to explain an interaction between a pointing device and a pointing target being a remote screen, to move a cursor up and down on the screen, can be equally applicable to the scenario of a pointing device moving up and down to control the volume of a pointing target being a speaker.

An interaction can be any action from any device of the system, such as the pointing device or pointing target, that has an effect on other device of the system. For example, an interaction could be displaying a cursor on a screen at the intersection between the pointing direction line of the pointing device and the screen, when the pointing target is the screen. As another example, an interaction could be selecting a pointed object, such as in the case of point and select applications. Other forms of interactions are possible, such as unlocking and controlling a remote computing device connected to a monitor or video projector, remotely controlling a smart television, remotely controlling a set-top box connected to a TV screen, displaying a contextual smart remote user interface based on the identification of the pointed target (real or virtual), determining a piece of equipment to be controlled based on the pointing direction of the pointing device, controlling an audio or video playback based on the pose or/and orientation of the pointing device, and the like. Different applications of the systems and methods disclosed herein will be described in the following disclosure.

The systems disclosed herein can include the pointing device itself, the pointing target itself, or a combination of pointing devices and pointing targets. The system could also include supporting devices, such as a base or charger for the pointing device, and remote devices such as a server or cloud architecture in operative communication with those supporting devices or the pointing device. Throughout this disclosure reference will be made to non-transitory computer readable media storing instructions to allow the disclosed systems to conduct certain actions. In these embodiments, the computer readable media can all be internal to the pointing device. Alternatively, the computer readable media can all be internal to the pointing target. The computer readable media can be distributed across the supporting devices, remote devices, the pointing device, and the pointing target, or they can be entirely located on the supporting devices and/or remote devices.

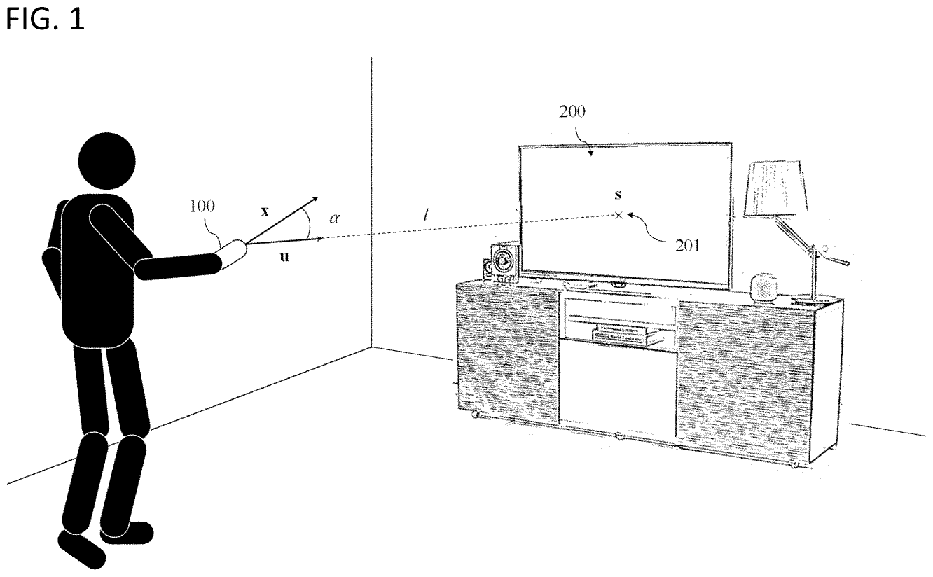

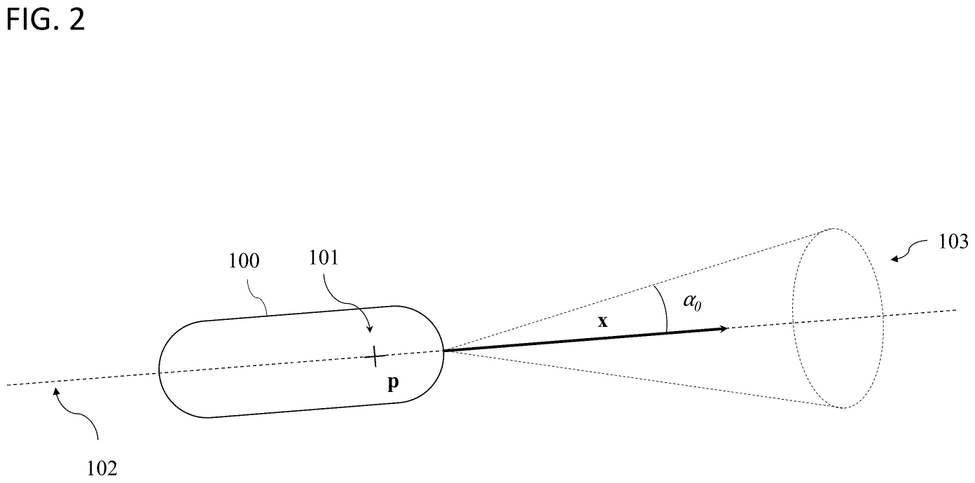

FIG. 1 illustrates an example of a 3D environment where a pointing device and a pointing target can be used in accordance with specific embodiments of the present invention. In the example of FIG. 1, the pointing device is the form of a portable device 100, and the pointing target is in the form of a remote screen 200. The portable device 100 is being held by a user and can be used to interact with the remote screen 200 that is positioned in a living room. The pointing direction of the portable device 100 can be determined by using geometrical parameters and a coordinates system. The coordinate system can be linked to the portable device. In specific embodiments of the invention, the coordinate system can be centered on the portable device 100. The coordinate system can be used, for example, to determine the orientation in the space of the portable device 100, relative to the screen 200. FIG. 2 illustrates an example of the coordinates system relative to the portable device and selection cone in accordance with specific embodiments of the invention.

The coordinate system can be centered on a point 101 of the portable device 100, as illustrated in FIG. 2. The point 101 could be located close to the front and centered laterally in the portable device. The point 101 is also referred to as point p in the following disclosure.

Referring now to both FIG. 1 and FIG. 2, the pointing direction of the portable device can be represented by a unitary vector x and, for example, defining a longitudinal direction of the portable device. The position of the screen 200 can be defined by a point s, referenced as point 201 in FIG. 1. In specific embodiments of the invention, the point s is a point of interest 201 of the pointing target or surface. If the surface is a TV screen, such as screen 200, the point of interest 201 could be the center of the screen 200. Alternatively, the point of interest 201 could be located at any other position on the screen or otherwise associated with the pointing target.

In specific embodiments of the invention, the direction of the screen 200 from the to the portable device 100 can be derived from the following equation:

u=s−p/l

Where:
p is the three-dimensional cartesian coordinates of the point 101; and
s is the three-dimensional cartesian coordinates of the point 201;
l=∥s−p∥ is the distance between s and p; and
u is the unitary vector parallel to the line passing by the point 101 and the point of interest 201, and with a direction from point 101 to point 201.

According to specific embodiments of the invention, the location of the portable device is measured by the distance l between the points 101 and 201, and the unitary vector u.

The angle α formed between vector x and vector u can materialize the pointing angle of the portable device 100 relative to the screen 200.

In vector notations:

cos α=x·u

In matrix notations:

cos α=x^{T}u

Accordingly, in specific embodiments of the invention, when the portable device 100 points exactly to the center of the fixed screen 200, the angle α is null. In other words, the vector x and the vector u are the same.

In the example described above, the pointing direction of the portable device 100 could be limited to a single line. That is a narrow way of assessing that the portable device 100 is pointing exactly to the point of interest 201 of the screen 200.

Still with reference to FIG. 2, a pointing cone 103 can be used in order to determine a condition of interaction with the pointing target. For instance, the interaction could be the selection or control of an interface or of an object when the portable device is pointing towards the point of interest 201.

The pointing cone in the example of FIG. 2 has a base located in the point 101 (also referred to as point p), an orientation defined by the vector x and an aperture α₀. The center of the cone can be defined by the axis 102 of the pointing device, which can be aligned with the pointing direction of the pointing device. In specific embodiments of the invention, if the point of interest 201 of screen 200 of FIG. 1 is located inside the pointing cone 103, the pointing device can be deemed pointing at the screen 200. In other words, for any angle α that is smaller than angle α₀, the condition of interaction is met. For instance, in a point and select application, the portable device 100 could interact with the screen if the angle α is smaller than the angle α₀.

In specific embodiments of the invention, the aperture angle α₀ can be a threshold angle, and the pointing device can identify a pointing target based on the pointing angle α and the threshold angle when the pointing angle is smaller than the threshold angle. The threshold angle α₀ can be known to the system. For example, the value of the threshold angle can be stored in a memory of the system. The value of the threshold angle can be embedded in instructions stored in a computer readable media of the system for geometrical parameters calculation. The threshold angle can be a tolerance of the system. The threshold angle can be defined by the system manufacturer or set by the user according to the user preferences and tolerance according to the application. The threshold angle can be associated to an area on the pointing target, for example a circular area such as the base of the cone 103, so that when the pointing device is closer to the pointing target, the angle is wider.

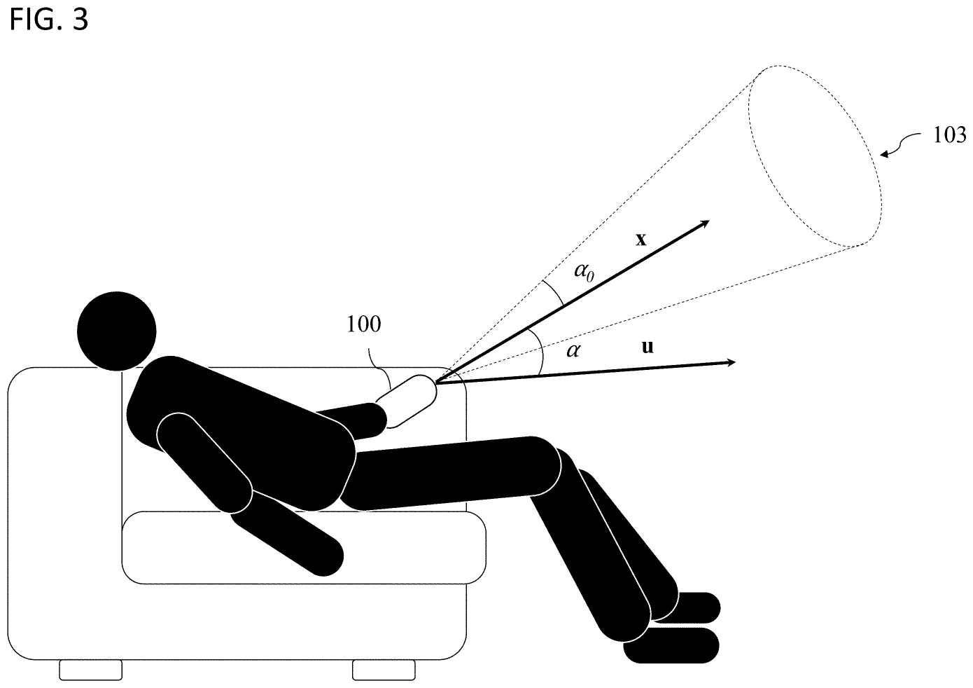

In specific embodiments of the invention, both the orientation and the position of the portable device 100 with respect to the screen 200 are important in determining whether a condition of interaction is met. FIG. 3 illustrates an example of the pointing device in a deselected pose. In this example, a user is sitting down holding the pointing device 100. In a “point and select” application for instance, it may be helpful to determine whether the portable device 100 is pointing to the point 201 of the fixed screen 200. In the illustrated pose, the portable device 100 is not pointing to the fixed screen, and therefore there is no selection. Indeed, the product of vector u and vector x would be too high. As visible on the illustration, when vector u is positioned at point 101, this vector u extends outside of the pointing cone 103.

The pose of the pointing device 100 can be defined as the combination of its position coordinates and its orientation coordinates in the space. Each coordinate (either in position or in orientation) can be presented by three variables to be determined in a 3-dimensional space. The pose of the pointing device 100 in the 3-dimensional space can therefore be defined with six variables. There can be ambiguity in the pose in a situation in which there is at least one missing coordinate (either in position or in orientation).

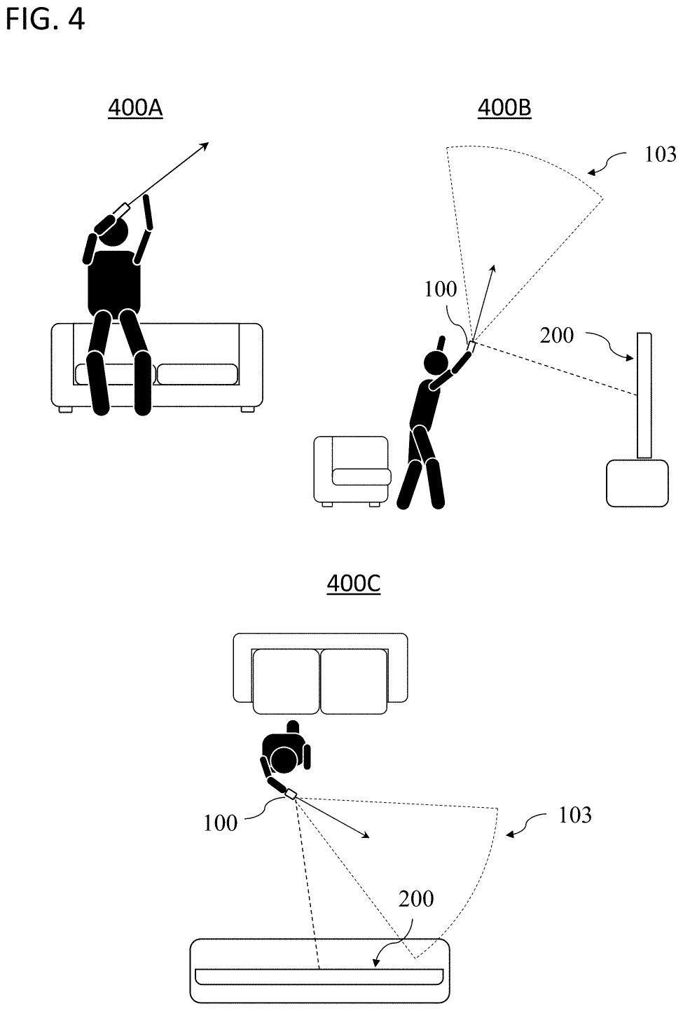

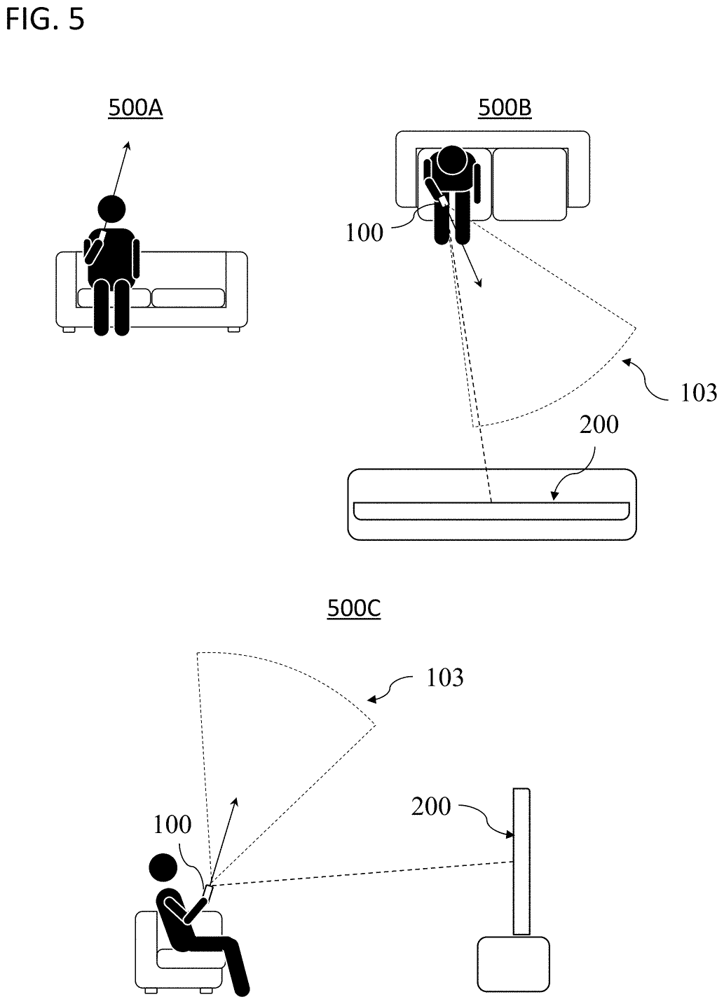

For example, FIG. 4 illustrates a front view 400A, a side view 400B, and a top view 400C of a scenario where a user is standing in a deselected pose. It is understood that these views are 2D projections in a coordinate system that is relative to the earth. It is clear from each of the 2D projections that the pointing device is not pointing to the screen. However, this is not always the case, as can be seen in the example of FIG. 5.

FIG. 5 illustrates a front view 500A, a top view 500B, and a side view 500C of a scenario where a user is sitting in a deselected pose. It is understood that these views are 2D projections in a coordinate system that is relative to the earth. In view 500B the pointing device appears as pointing towards the screen in this particular 2D view. Indeed, in the 2D projection in a horizontal plane of the pointing cone, it appears as if the center of the point of interest is located inside the pointing cone 103. In view 500C however, it is clear that, with the vertical dimensions, the point of interest is located outside of the pointing cone 103. Therefore, the portable device is not pointing towards the screen.

The above examples and illustrations in 2D views show that the particular measurement of the angle a allows a simple determination of the selection or not, through a judicious selection of coordinates. In specific embodiments of the invention, the configuration of antennas in the system allows for the determination of geometrical parameters, such as angle a, to facilitate the identification of and the interaction with pointing targets.

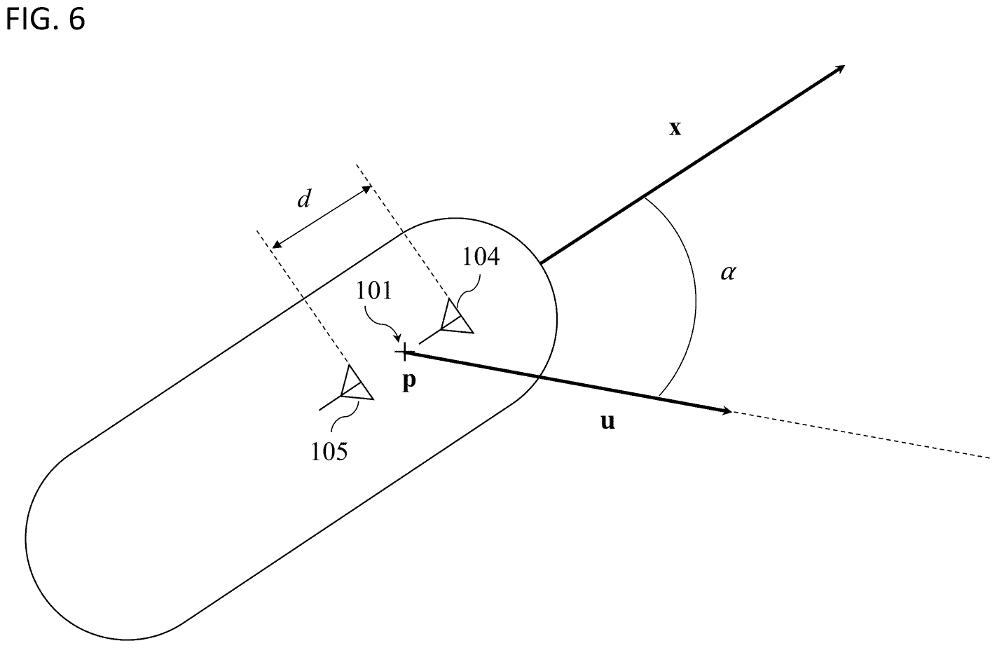

In specific embodiments of the invention, the pointing device comprises a set of antennas. An example of the configuration of antennas of the pointing device in accordance with specific embodiments of the invention can be explained with reference to FIG. 6. FIG. 6 illustrates a two-dimensional representation in the plane passing through the point 101 of the portable device, and parallel to both vectors u and vector x. In the example of FIG. 6, the portable device comprises a front antenna 104 and a rear antenna 105, configured for receiving and/or transmitting signals, such as UWB radio signals. These antennas in the example of FIG. 6 are substantially aligned with the pointing direction defined by vector x. The antennas can be aligned with the pointing direction in that a line connecting a center of the first antenna to a center of the second antenna is parallel with the pointing direction. The antennas can be arranged so that the point 101, introduced with reference to FIG. 2, is located in the middle of antenna 104 and antenna 105.

In specific embodiments of the invention, this particular configuration of antennas allows to a greater tolerance to an ambiguity in position or/and in orientation of the pointing device for certain interactions, such as a “point and control” or “point and select” interactions. In specific embodiments of the invention, the particular configuration of the pointing device, to measure the angle α, allows for a determination of the condition of interaction without requiring a full resolution of all the variables that would otherwise be needed to determine both the pose and location of the portable device. For example, the particular configuration of antennas could allow for the determination of geometrical parameters with techniques such as angle-of-arrival in order to determine angle α, and thus determine a condition of interaction.

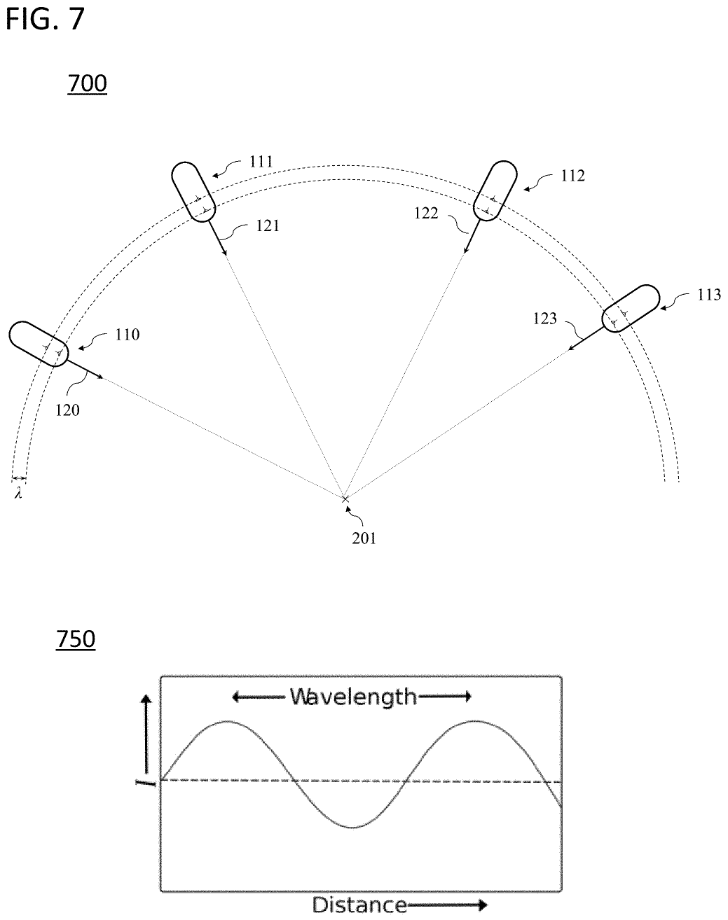

FIG. 7 illustrates an example of a two-dimensional representation 700 of a plurality of possible locations 110, 111, 112, and 113 of the portable device 100, in a respective orientation 120, 121, 122, and 123. In each pose (position+orientation) of the portable device 100 in FIG. 7, the portable device is pointing towards the screen 200, and more specifically towards the point of interest 201. In specific embodiments of the invention, the distance between the antennas in the pointing device, for example between antennas 104 and 105 of FIG. 6, (intra-antenna distance) can be comprised between half a wavelength to a full wavelength X of an electromagnetic wave, such as the carrier wave of a UWB signal. As represented in graph 750, the carrier wave wavelength is a spatial period of a periodic wave, the distance over which the carrier wave's shape repeats, of received or transmitted UWB radio signals. The electric field is represented by letter I.

The particular configuration of intra-antenna distance in accordance with specific embodiments of the invention is not conventional, as angle-of-arrival systems are commonly designed with an intra-antenna distance lower than half a wavelength (λ/2) in order to prevent an angle wrapping (as explained in more details below). However, in the antenna configuration aligned with the pointing direction in accordance with specific embodiments of the invention, it is possible to tolerate a lower angle wrapping limit (as explained in more details below). This can help compensate the reduction in angular precision of the system with antennas that are aligned with the pointing direction.

Phase or angle wrapping is a situation in which measurements give rise to an ambiguity about the direction from which the electromagnetic wave is coming, with a lack of distinction between two opposite sides. This issue can be understood as electronical sensor systems, such as UWB sensors, can only measure phase modulo 2π, i.e., <2π uncertainty. For instance, an UWB sensor could not be able to tell the difference between a signal measured at phase: ψ, ψ+2π, or ψ+4π.

In a configuration in accordance with specific embodiments of the invention, different values of a are possible when the intra-antenna distance d is superior or equal to ½λ. That said, in the particular configuration of antennas substantially aligned with the main pointing direction in accordance with specific embodiments of the invention, there can be a benefit in increasing the intra-antenna distance d beyond ½λ as it is unlikely a user would point away from the pointing target. In specific embodiments of the invention, increasing the intra-antenna distance d can provide a benefit by increasing the accuracy of the measurement.

In specific embodiments of the invention, the intra-antenna distance d is lower or equal to λ, so as to have a good tradeoff between the accuracy and the possibility of an angle wrapping. The table below illustrates an example of a possible relationship between the intra-antenna distance and the likelihood of angle wrapping for certain pointing angles. The expected range of the pointing angle is set by the fact it is expected that a user will not be pointing the pointing device in the entirely wrong direction.

| Intra-antenna | Expected range of | Possible angle |
|---|---|---|
| distance (d) | pointing angle α | wrapping? |
| ½ λ | [0, 2π] | None |
| ¾ λ | $[ 0 , \frac{3 π}{2} ]$ | Very unlikely |
| λ | $[ 0 , \frac{π}{2} ]$ | Unlikely |

In accordance with specific embodiments of the invention, for various applications such as a portable device interacting with a fixed screen, the portable device can be deemed globally pointing in the direction of the fixed screen. Then, a likely absolute value for the pointing angle α would be comprised between 0 and ½π.

According to specific embodiments of the invention, in order to maximize the phase difference and/or accuracy recorded at the two antennas 104 and 105 of FIG. 6, it is possible to consider approaches in which both antennas 104 and 105 are aligned with the pointing direction of the portable device and configured so the angle wrapping corresponds to pointing angle wrapping between ½λ and λ.

In specific embodiments of the invention, the signal (such as a UWB signal) to be received by the antennas of the pointing device of FIG. 6 can come from a forward-looking zone as determined by the vector x and vector u and in front of the line formed by antennas 104 and 105. In specific embodiments of the invention, it would be uncommon to have someone pointing the fixed screen 200 of FIG. 1 with the rear of the portable device 100 oriented to the fixed screen 200 instead of its front. Then, in specific embodiments of the invention it can be assumed that antenna 104 receives the signal first in comparison to antenna 105, and that the phase difference is positive.

In specific embodiments of the invention, in a configuration with antenna 104 and antenna 105 aligned in the pointing direction of the portable device, and with basic assumptions, angle wrapping can be very limited in the range of distances between antennas comprised between ½λ and λ.

One drawback to be noted is that, in specific embodiments of the invention, when antennas 104 and 105 are aligned with the vector x (pointing direction of the pointing device), small change in the pointing angle α, could only give rise to very small change in phase difference.

Then, in specific embodiments of the invention, one way to obtain more sensibility for a given pointing angle α is to increase the intra-antenna distance d, thus a bigger phase difference could be measured. Eventually, a compromise with angle wrapping can be achieved according to specific embodiments of the invention. As explained above, angle wrapping has more chances to occur when the distance d between antennas is important. In specific embodiments of the invention, the distance d between antennas 104 and 105 can be substantially equal to the wavelength distance X. In accordance to specific embodiments of the invention, it is possible to further increase the intra-antenna distance d by fusing data from other sensor(s), such as for instance a magnetometer or an accelerometer.

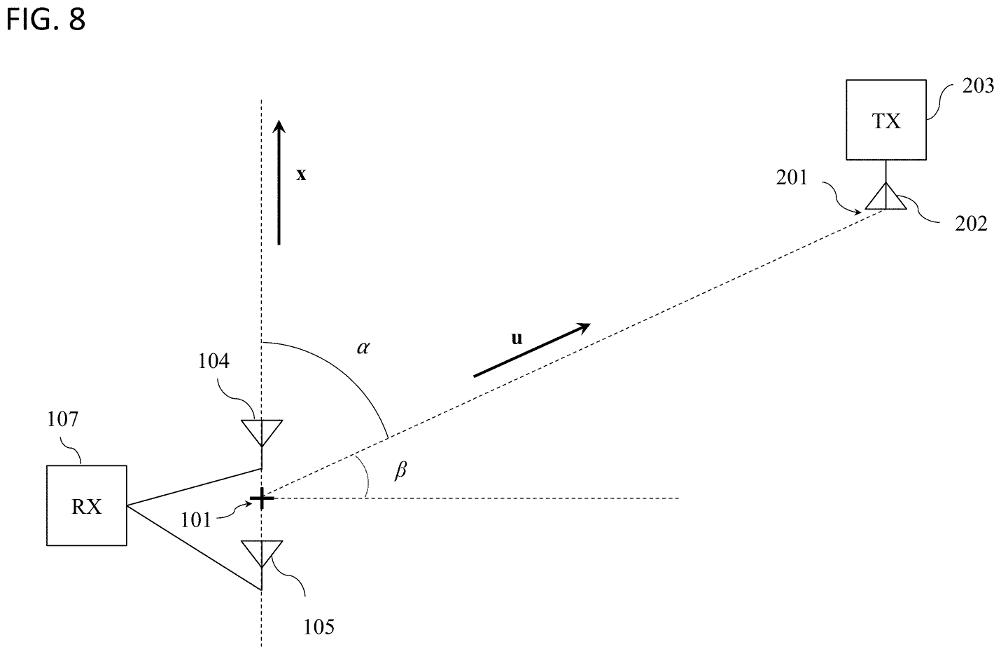

Reference will now be made to FIG. 8. FIG. 8 illustrates an example of a system for angle-of-arrival measurement in a two aligned antenna configuration in accordance with specific embodiments of the invention.

In specific embodiments of the invention, the system can be an Ultra-Wideband (UWB) sensor system. An Ultra-Wideband (UWB) is a short-range radio technology which can be used for indoor positioning. The enlarged spectrum bandwidth of UWB technologies allows a very good discrimination of the signal time of arrival. This very good time discrimination allows a very good Time of Flight (TOF) estimation and, as of today, distances estimation with errors limited to just a few centimeters in contrast to Bluetooth Low Energy and Wi-Fi. Said in another way, the positioning can be done with a transit time methodology (TOF) instead of the measurement of signal strengths (Receive Signal Strength Indicator or RSSI). Although an UWB sensor system is disclosed in specific embodiments of the invention, the invention is applicable to other systems and radio technologies.

A system in accordance with specific embodiments of the present invention can include a portable system (such as a portable UWB system), attached to, or positioned in or near to, or otherwise associated to, the pointing device 100. The system can also include a fixed system (such as a fixed UWB system), attached to, or positioned in or near to, or otherwise associated to, the pointing target, such as the fixed screen 200. The systems are defined as portable and fixed in order to differentiate them throughout this disclosure, being the portable associated to the pointing device and the fixed associated to the pointing target, in accordance with specific embodiments of the invention. However, this should not be considered a limitation of the invention. The pointing target could be a non-fixed target and the pointing device could be a non-portable device. The pointing target could be a non-fixed target and the pointing device could be a fixed device, for example, for identifying or locating pointing targets. This and other variations of the systems disclosed herein are also included within the scope of the present invention.

The portable system can comprise a receiver 107 (such as a UWB receiver), connected to the antennas 104 and 105. The antennas 104 and 105 can be UWB antennas. The portable system can also include a chipset or more (not shown) for processing electromagnetic signals (such as UWB electromagnetic signals) received by the two antennas. In specific embodiment of the invention, the receiver 107 can be a transceiver or a transmitter. The portable system can also include a computer readable media storing instructions to be executed by the system in order to execute the intended functions.

The fixed system can comprise a transceiver 203 (such as a UWB transceiver) connected to at least one antenna 202 (such as and UWB antenna). The fixed system can also include a chipset or more (not shown) for generating electromagnetic signals (such as UWB electromagnetic signals) to be transmitted by the antenna 202. In specific embodiment of the invention, the transceiver 203 can be a receiver or a transmitter. The fixed system can also include a computer readable media storing instructions to be executed by the system in order to execute the intended functions.

In specific embodiments of the invention, an angle β represents an angle-of-arrival, which can be the angle between the direction of the incident electromagnetic signal transmitted by the fixed system, and the plane of all points that are at equal distance between the antennas 104 and 105. The angle-of-arrival β is represented in the illustrations in the two-dimensional plane passing through the point 101 of the portable device, and parallel to both vector u and vector x. The angle α can be deducted from the measurement of the angle-of-arrival β with the following formula:

$$α = \frac{π}{2} - β$$

It is possible to perform an equivalent angle-of-arrival measurement with a system having more antennas on either side. For instance, the pointing device (or portable device) antennas and/or the pointing target (or fixed surface) antenna could be replaced by an array of antennas. In case of an array of antennas, on receiver 107, the point 101 could be defined as the center of gravity of the field generated by the antennas in the pointing device 100. In a similar fashion, on transceiver 203, the point 201 could be defined as the center of gravity of the field generated by the antennas on the pointing target, such as fixed screen 200.

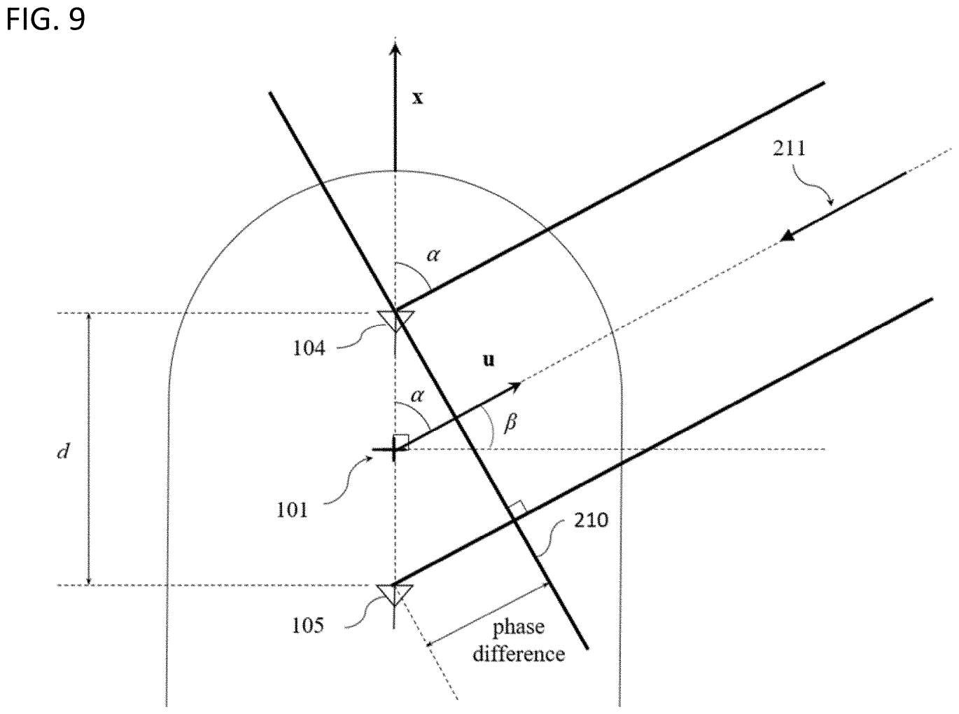

FIG. 9 illustrates the relationship between angle-of-arrival (AOA), pointing direction and position of the pointing device. FIG. 9 illustrates an incident wavefront under far-field assumption where the distance d between both antennas 104 and 105 can be negligible in comparison to the distance between the pointing device 100 and the pointing target 200. The direction of the incident electromagnetic signal transmitted by the fixed system is represented by arrow 211. In this situation, an electromagnetic wave transmitted by the transceiver 203 via the antenna 202 can be received as an incident wavefront by the receiver 107 via the antennas 104 and 105.

Then, a measure of the phase difference between antennas 104 and 105 can be used to derive the measure of the angle-of-arrival when the two antennas are organized along the pointing direction of the pointing device:

$${ψ}_{2} - {ψ}_{1} = \frac{2 π d}{λ} cos α \pm 2 k π$$

where:

k is an integer;

ψ₁ is the measure of the phase of a determined electromagnetic wave on antenna 104, not to be confused with φ (lower case) representing an angle; and

ψ₂ is the measure of the phase of the same determined electromagnetic wave on antenna 105.

A calculation yields:

$$cos α = \frac{λ}{2 π d} ( {ψ}_{2} - {ψ}_{1} ) modulo 2$$

In specific embodiments of the invention, by placing the antennas in the pointing device aligned with the pointing direction of the device, it is possible to determine a condition of interaction, for example whether the device is pointing to a certain target or not, by determining the geometrical parameters such as angles α and/or β rather than a full set of coordinates. This approach can be different than others where the antennas are located, for example, side by side on an axis perpendicular to the pointing direction, where there may be no phase difference between the antennas when the pointing device is tilted, requiring the addition of a third antenna in a different plane to complete the measurements or other solution to determine a pointing angle or pointing direction of the device.

In specific embodiments of the invention, it is possible to use a system such as the one described with reference to FIG. 8 and FIG. 9 to determine the difference between the phase of a signal as received by each antenna in the pointing device, such as antennas 104 and 104. This phase difference could be used to determine an angle of interest, such as angles α and/or β. The angles could indicate a pointing direction of the pointing device, and/or be used in the identification of pointing targets, points of interests or otherwise be used to set an interaction between devices. In specific embodiments of the invention, the system can determine a pointing target of the pointing device using a comparison of a signal received from a source associated with the pointing target. The system can include computer readable media storing instructions to cause the system to execute the above-mentioned determinations. The system could also include phase detection circuitry and hardware for the processing of the received signal in order to obtain the necessary data to proceed with the angle-of arrival calculations.

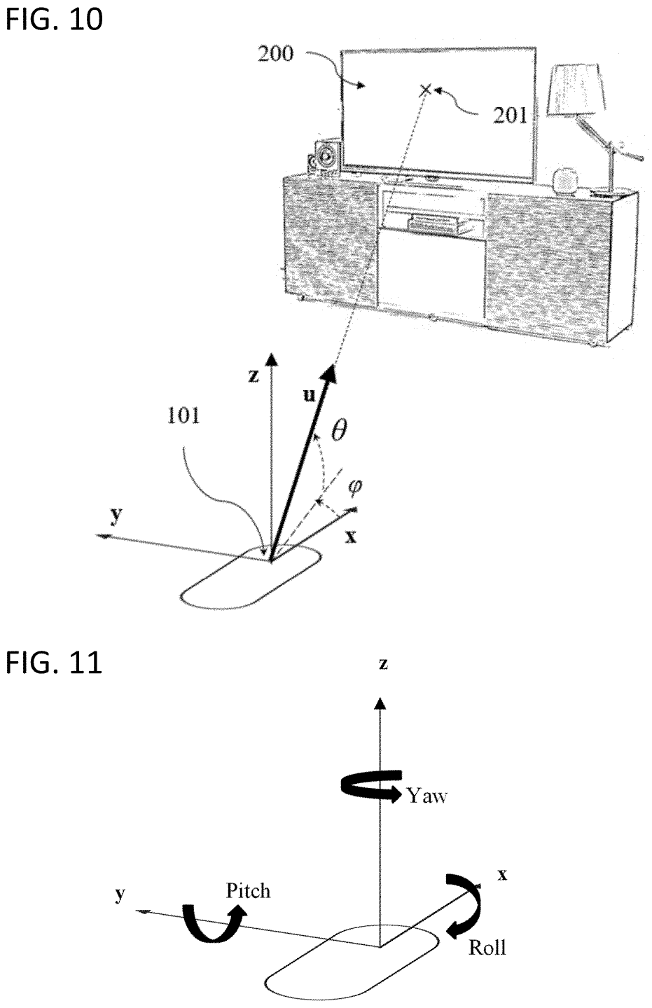

FIG. 10 illustrates an example of the spherical coordinate system and cartesian coordinate system of the pointing device. FIG. 10 illustrates an azimuth angle φ (not to be confused with the phase value introduced above and received by the antennas), and elevation angle θ.

The pointing angle α can be viewed as a combination of the azimuth angle φ and the elevation angle θ. In a non-spherical/polar coordinates system centered on the pointing device 100, it can be possible to define a cartesian coordinate system formed by three axes x, y and z and centered on point 101:
the x-axis could correspond to the longitudinal axis of the pointing device;
the y-axis could correspond to a lateral axis of the pointing device, and
the z-axis could correspond to a vertical axis of the pointing device, in the sense that this axis could correspond to the upper direction with respect to the pointing device (and not the Earth).

In specific embodiments of the invention, those axes can be centered on the portable device p and can be linked to inertial measurement units (IMUS), including for instance gyroscopes to measure an angular speed.

FIG. 11 illustrates the yaw, pitch and roll angles that can be associated with the three axes x, y and z introduced above. The roll angle can correspond to a rotation around the longitudinal x-axis of the pointing device. The pitch angle can correspond to a rotation around the lateral y-axis of the portable device. The yaw angle can correspond to a rotation around the vertical z-axis of the portable device.

The pose of the portable device 100 can be a combination of its position coordinates and its orientation coordinates in a three-dimensional space. Each position or orientation can be represented with three variables. The pose of the portable device 100 in the 3-dimensional space can therefore be defined via six variables. As explained before, there may be an ambiguity in a situation in which there is at least one missing coordinate. Ambiguity can be a situation in which there is at least one missing coordinate (either in position or in orientation) of the pointing device 100.

In specific embodiments of the invention, for variables related to the pointing device 100 orientation, it can be determined whether the portable device goes left or right (via the measure of the azimuth angle φ), and up or down (via the measure of the elevation angle θ).

In specific embodiments of the invention, a precise value of the pointing angle is not necessary to be determined. For example, in the case of certain applications where the condition for interaction is met when the absolute pointing angle is smaller than a threshold, regardless of where exactly the user pointed to around the point of interest, only the absolute value of the pointing angle would be enough to determine the condition of interaction.

In specific embodiments of the invention, it can be desired to obtain a more precise information as to the position and pointing direction of the pointing device. In specific embodiments of the invention, it can be desired not only to determine a condition of interaction but also to determine the exact position of the pointing device with respect to the pointing target, with no ambiguity. In specific embodiments of the invention, the precise pointing direction could be determined by a combination of the antenna configuration described above and additional measurements. In specific embodiments of the invention, additional antennas, sensors and the calculation of additional geometrical parameters can afford more accuracy to the measurements. For example, additional transmitting antennas associated with the pointing target could be used to determine second, third, or more angles to thereby obtain an increasing degree of information concerning the precise pointing direction of the pointing device. As another example, additional receiving antennas associated with the pointing device could be used to determine additional angles to thereby obtain an increasing degree of information concerning the precise pointing direction of the pointing device. As another example, sensor fusion with other sensors such as magnetometers, gyroscopes, and inertial measurement units could be used to determine the precise pointing direction of the pointing device. These three classes of approaches could also be used in combination to increase the accuracy of the system.

In specific embodiments of invention, the angle-of-arrival information while real-time and frequently refreshed can be subject to jitter noise. In those embodiments, using the angle-of-arrival information to estimate the pointing direction of the portable device could make, for example, a cursor “jump” on the screen.

In specific embodiments of the invention, by integrating angular velocity, orientation estimate can be subject to a slow drift in time. This drifting error may be acceptable for systems simply relying on “relative” positioning, such as an air wand for a gaming system for instance. By relative positioning it is meant that the cursor must go to the left when the user is orienting the device to the left, and to the right when the user is orienting the device to the right. The drifting error may also be acceptable in an air mouse portable device equipped with a button. For instance, if a user wants to go further into a direction but already have its wrist fully oriented in this specific direction, a button can be pressed (or released) in order to stall the air-mouse system the time needed to position the user's arm to a more central position and orientation. That way, the user is free again to move its arm the way he wants. This “stalling” system is close to the effect of holding up a traditional roller mouse controller above the desk to replace it at a more central position on the desk. In those cases, there may be no exact mapping between the spatial configuration of the system and the cursor projection on screen, the mapping can be shifted each time the air-mouse system is stalled.

In specific embodiment of the invention, by comparing the angular velocity measured by the angle-of-arrival system and measuring the angular velocity given, for example by a gyroscope, it can be possible to retrieve the exact pointing direction of the portable device 100. The data from the system and additional sensors can be fused. This kind of data fusing could be done by using, for example, a Kalman filter.

To that end, in specific embodiments of the invention the pointing device 100 may further include an inertial measurement unit (IMU) comprising one or more electronic sensors to measure a specific force, an angular rate of motion (i.e. an angular speed), and/or the absolute orientation of the portable device, using a combination of accelerometers, gyroscopes, and sometimes magnetometers. A gyroscope may provide angular speed data. A magnetometer may provide an orientation vis a vis a local magnetic field (from the terrestrial magnetic field or/and local magnetic source), although this can be not very accurate for some applications. A set of accelerometers may provide a 3-axis acceleration data. For instance, it can be possible to derive orientation data based on accelerometers, by identifying the gravity (vertical acceleration/force) from the accelerometers data.

The accelerometers can include an electrostatic capacitance (capacitance-coupling) accelerometer that is based on silicon micro-machined MEMS (Micro-Electro-Mechanical Systems) technology, a piezoelectric type accelerometer, a piezo-resistance type accelerometer, or any other suitable accelerometer.

In specific embodiments of the invention, the additional IMU data from the pointing device provides physical variables that can be integrated, along with the AOA data from the portable/fixed system. For instance, the portable device may integrate the gyroscope angular velocity (one type of IMU data).

A list of IMU sensors and the use of physical variables is described in more details in the U.S. Pat. No. 10,068,463 B2, entitled “Methods for the determination and control of a piece of equipment to be controlled; device, use and system implementing these methods”, incorporated herein by reference in its entirety for all purposes.

According to specific embodiments of the invention, the IMU data can be fused with angle-of-arrival data to provide a precise estimate of the height of the pointing device 100 along with an estimate of the position of the pointing device 100 on the horizontal plane. For instance, gyroscope data and the angle-of-arrival data can be combined with other input using Kalman filters as will be described below. This could enable a combination of both the advantage of smooth IMU sensor data (e.g. from a gyroscope) together with angle-of-arrival data (no drift), with Kalman filters as explained in more details below. The system could include a computer readable media storing instructions to allow the system to determine the angular velocity using the geometrical parameters such the angles calculated with the angle-of-arrival techniques. Additionally, the system can be able to collect sensor data from the sensor mentioned herein, such as gravity sensors, magnetometers, and an inertial measurement unit and determine the angular velocity by using that sensor data. Additionally, the system can have instructions stored to perform sensor function and determine a global pointing direction of the pointing device using the angular velocities determined from the different sources in the system.

In specific embodiments of the invention, with the gyroscope, depending on the hypothesis concerning the position and the orientation of the pointing device 100, what would be measured by the angle-of-arrival system can be predicted. If those two information sources are concordant, then the position and orientation hypothesis for the portable device can be deemed right. If not, then another hypothesis for the position and the orientation of the portable device 100 could be considered. The Kalman Filter is one way to address this kind of situation.

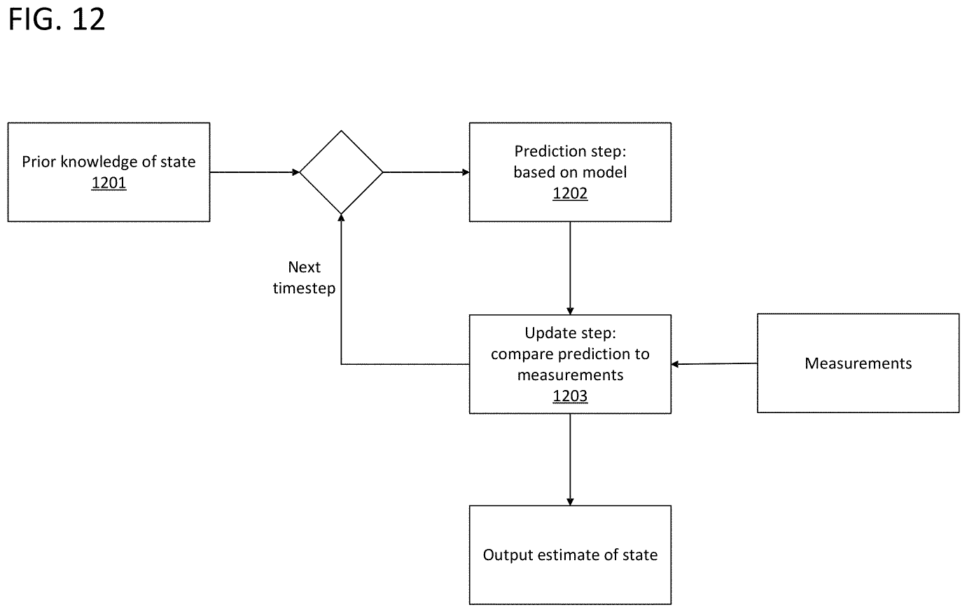

FIG. 12 illustrates an example of a flow chart for fusing data from a plurality of input sources to estimate the position of the pointing device 100, that can represent the pointing direction of the pointing device on a pointing target such as a fixed screen.

The raw input data from the sensors can be fused in order to compute an interaction, such as a projected cursor position on a fixed screen. According to specific embodiments of the invention, the raw input data can be fused by a software program, a dedicated hardware or a combination of dedicated hardware and software, implementing a Kalman filter pipeline.

The following paragraphs describe a configuration for fusing the data from a plurality of input sources to estimate the position of a portable device representing the pointing direction of the portable device on a fixed screen, in accordance with specific embodiments of the present invention.

The Kalman filter pipeline can be used for fusing a variety of different observations (varying in nature, dimensionality and confidence) to get a semi-optimal estimate of the position and orientation of a mobile object such as the pointing device 100.

The Kalman filter pipeline can include a tradeoff between priori estimate 1201 (propagated in the future by the prediction step 1202), and correction by measurements (implemented by the update step 1203).

According to specific embodiments of the invention, a software can also allow real-time fine tuning of the sensors intrinsic parameters in order to follow changes in calibration values. It can leverage redundancy in the information provided by the sensors in order to discard outliers and reinforce the estimate robustness.

A feature of a Kalman filter is that it can keep in memory an up to date estimation but also the uncertainty associated with this estimation, so with each new observation (coming with their own uncertainty parameter), precise adjustment of the tradeoff between prior estimate and new information sources during update can be done. More practically, the Kalman filter can be encoding this uncertainty through a covariance matrix, encoding the variance at each dimension on its diagonal but also the way dimensions are correlated together through its off diagonal parameters. That way, it can be possible to determine how a change in one dimension could affect others (e.g., how a correction in position should affect the last velocity estimate).

In specific embodiments of the invention, the portable device antennas can be aligned along the longitudinal axis of the pointing device 100. The portable device 100 can be enclosed in a housing/case and so can be also the antennas inside it. In those embodiments, the longitudinal axis of the pointing device could be aligned with the pointing direction of the pointing device, and the antennas could be aligned with the pointing direction of the antennas as was described previously in this disclosure.

In specific embodiments of the invention, the pointing device can be a smartphone device. There are multiple antenna configurations for a smartphone device in accordance with specific embodiments of the invention (which could be used to other types of pointing devices).

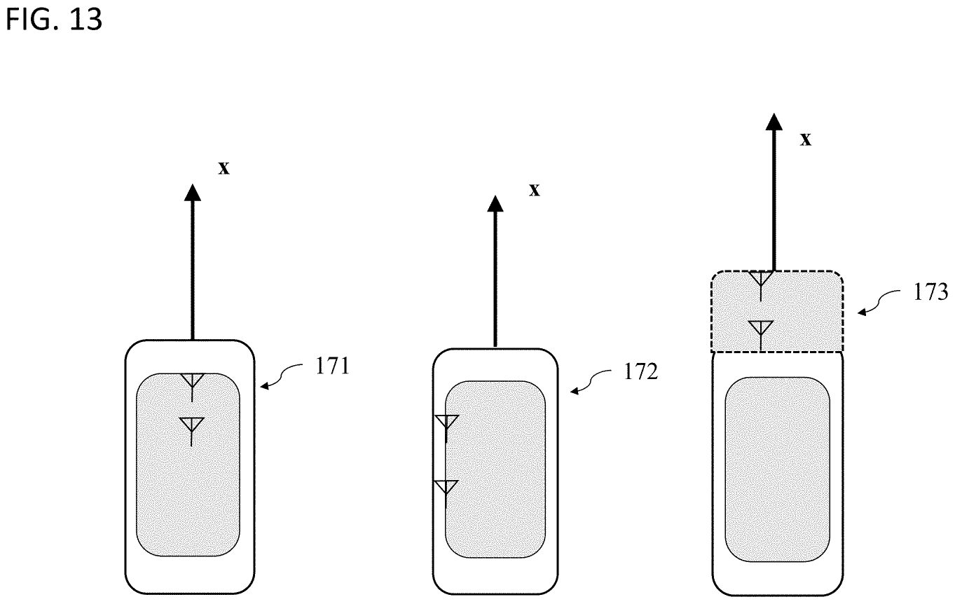

FIG. 13 illustrates different antenna configurations for a pointing device, such as a smart phone devices, in accordance with specific embodiments of the invention.

The pointing device 171 comprises antennas located at the superior extremity. By using this particular configuration, it can be possible to avoid the obstruction of electromagnetic waves from the hand of a user, which can produce a higher signal-to-noise ratio.

The pointing device 172 comprises antennas located on a lateral side, specifically the left-hand side of the device. The antennas in this configuration could be further apart without obstruction of electromagnetic waves from the hand of a user, while preserving the antenna configuration aligned with the pointing direction.

The pointing device 173 comprises antennas located under a layer that can be transparent or semi-transparent to UWB waves, which could be for instance in the back side of the smartphone. Accordingly, the signal-to-noise ration could be optimized for UWB signal measurements, even if a touchscreen is opaque to UWB waves.

It is understood that functionally equivalent antenna configurations could be employed, for instance a configuration with more than two antennas. For instance, the different configurations with three antennas forming a triangle, a side or median of which is aligned with the pointing direction.

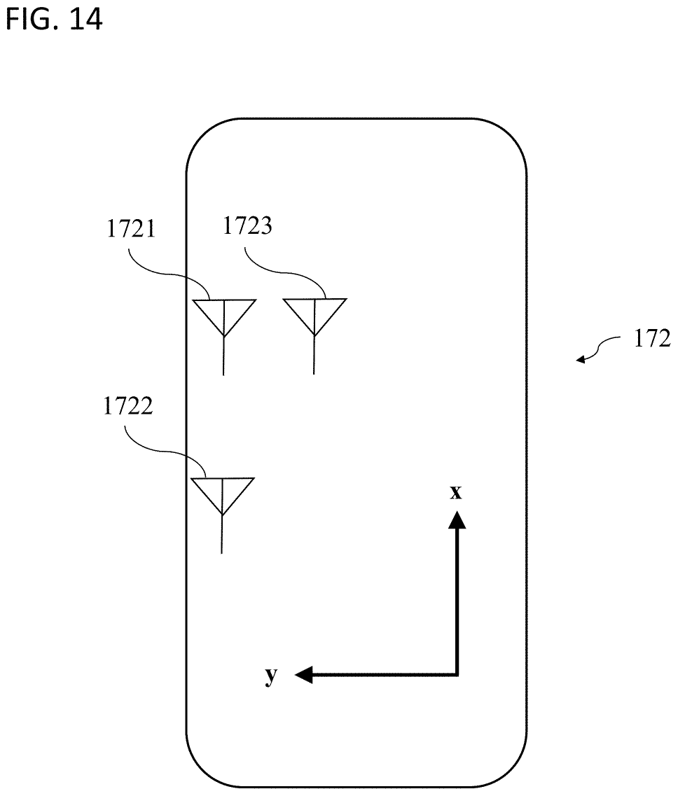

FIG. 14 illustrates an example of a possible configuration for a pointing device comprising 3 antennas. The pointing device 172 (illustrated both in FIG. 13 and FIG. 14) could comprise two antennas 1721 and 1722 substantially aligned with the pointing direction x of the pointing device, and another antenna 1723 not aligned with the previous two antennas.

In specific embodiments of the invention, the third antenna could be positioned so that the three antennas 1721, 1722 and 1723 form an equilateral triangle. In specific embodiments of the invention, the three antennas 1721, 1722 and 1723 can be positioned to form a right-angle triangle, in order to add more spatial information and resolve ambiguities.

According to specific embodiments of the invention, the distance between the antennas 1721 and 1722 (aligned with the pointing direction) can be substantially longer than the distance between the third antenna 1723 and one of the antennas 1721 (or 1722). In specific embodiments of the invention, this particular configuration could allow for a better accuracy for the measure of angle α (because of to the longer distance between 1721 and 1722) and a resolution of possible ambiguities because of the added spatial information that the third antenna 1723 brings (because of the shorter distance).

Additional antennas, such as UWB antennas, can be added to the pointing device to increase the number of spatial parameters, which could be used in combination, for example via Kalman filters, as explained above.

In specific embodiments of the invention, the pointing target, such as screen 200, can include more than one antenna. In specific embodiments of the invention, there can be at least two antennas associated with the pointing target. The pointing device can measure an angle-of-arrival with respect to each antenna of the fixed screen.

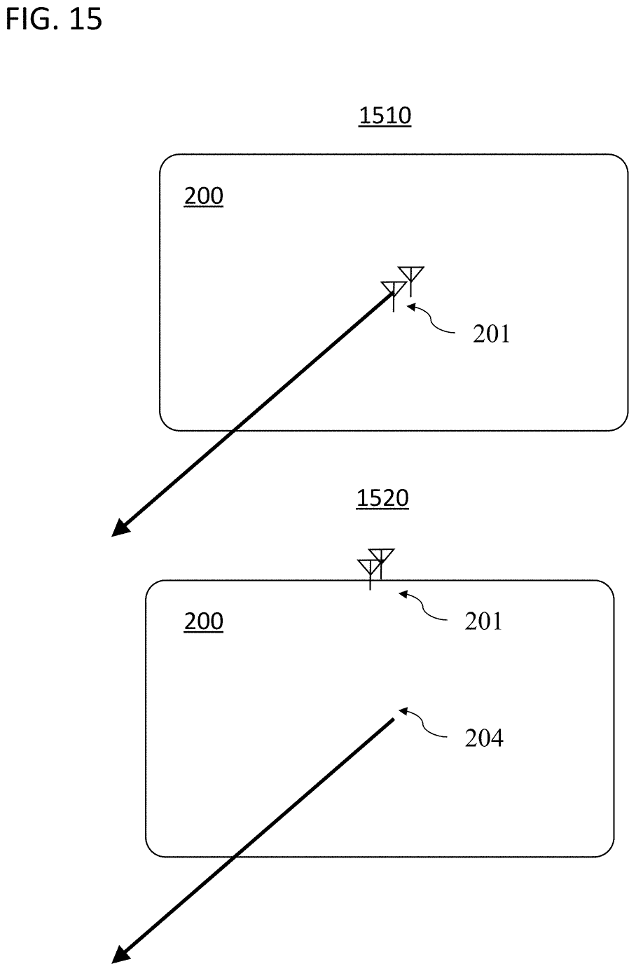

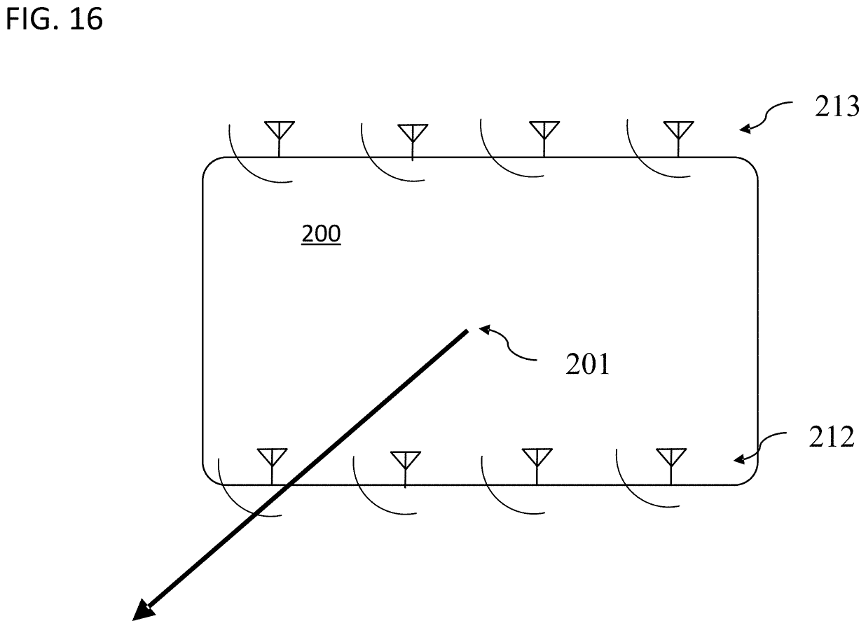

FIG. 15 illustrates two examples of antenna configuration of a pointing target, such as screen 200. The antennas could be a set of transparent antennas located in the center and front of a fixed screen. As represented with the example 1510, with this time non-transparent antennas located in the center of the fixed screen, both antennas can be located behind the fixed screen (if the display is transparent or semi-transparent to UWB electromagnetic waves). The antennas could also be placed within the display stack such as behind the light emitting elements of an LCD or plasma display but in front of a main PCB or ground shield of the display stack. As represented with the example 1520, antennas (either transparent or non-transparent) can also be located at the top of the fixed screen. In those embodiments, the point of interest 201 could be on the top surface of the pointing target. However, an actual point 204 of intended interaction could be offset from the antennas and the system can be configured to determine, through geometrical approximations, sensor circuitry or programmed logic, the point 204 of actual interaction when the pointing device points at point of interest 201.

In specific embodiments of the invention, the uncertainty as to where exactly the user is pointing can be cured or reduced by adding antennas associated with the pointing target. For example, when a set of angles is solved for a signal transmitted by an antenna associated with the pointing target, the pointing device can be deemed to be pointing to a point on the perimeter of a pointing cone with a vertex at the pointing device and centered around the antenna. In this way, if a second set angles is solved for using a second antenna associated with the pointing target, the uncertainty as to where exactly the user is pointing could be reduced to the at most two points where the two pointing cones intersect. If a third angle is solved for using a third antenna associated with the pointing target, the uncertainty as to where exactly the user is pointing can be reduced even further, or even cured, and the pointing device could be deemed to be pointing to the point where the three pointing cones intersect.

According to another specific embodiment of the invention, the fixed system may comprise a strip of antennas organized all around the periphery of the fixed screen.

FIG. 16 illustrates an example of a fixed system on a pointing target, such as screen 200, comprising an array of antennas (either transparent or non-transparent). A first strip of antennas 213 can be arranged on top of the screen, and a second strip of antennas 212 can be arranged at the bottom of the screen. In specific embodiments of the invention, for reasons of symmetry and geometry, the collection of antennas could be equivalent to a single antenna located at the center 201 of the fixed screen.

In specific embodiments of the invention, where the system comprises an array of antennas, the system can be configured to transmit a ser of signals using the array of antennas. The pointing device could then receive the set of signals at each of the antennas in the pointing device in the same way that was explained for the case of a single signal. The pose of the portable device could then be determined by determining the differences between the phases of the signals as received by one antenna of the pointing device and as received by another antenna of the portable device

In specific embodiments of the invention, with first considerations, one good placement for the antennas is the center of the screen, as represented in example 1510 of FIG. 15, because without more information, this could be considered the average pointing direction.

In specific embodiment of the invention, antennas can be located at the top of the pointing target, such as in the example 1520 of FIG. 15. Pointing errors made by humans have been determined and the applicant has observed that users tend to aim higher than needed with their pointing device. In order to compensate for this bias, the antennas can alternatively be positioned on the superior part of the pointing target (fixed screen).

Other options could include any positions on the point target that have a good probability to be pointed, or at the discretion of the system's manufacturer or the user.

A system in accordance with the embodiments described herein could be used in various applications.

For example, the system can be used for controlling a television, a smart television or a home theater system and more generally a controllable device. The pointing device can be configured as a virtual pointer, wherein the location at which the pointing direction intersects a pointing target surface is communicated for display on a screen of the television, smart television or home theater system. The pointing device can be configured as a remote controller, wherein the output data of the portable device is converted in control inputs of the user interface in the television, smart television or home theater system. The control inputs can be transmitted via existing physical communication interfaces (e.g. infrared signals, wireless signals). The control inputs can be configured to interact via an Application Programming Interface (API) of the controllable device.

As another example, the system can be used for controlling existing media systems having a variety of different input mechanisms. For example, some media systems may be controlled by a user providing inputs directly on an interface of the media system (e.g., by pressing buttons incorporated on the media system, or by touching a touchscreen of the media system). Data from the portable device could be provided to an API of an existing media system or to a connected pointing analysis module receiving telepointer data.

As another example, the system can be used for multimodal integration for the control of electronic components. For example, the system can be used for controlling electronic components in a ubiquitous computing environment. In particular, a pointing device can be used to control electronic components using multimodal integration in which inputs from a speech recognition subsystem, gesture recognition subsystem employing the data provided by a telepointer and/or a pointing analysis system receiving telepointer data, are combined to determine what electronic component a user wants to control and what control action is desired.

As another example, the system can be used in magic wand or controller for video game or entertainment system. For instance, the system could be used with a home video game system including a pointing device according to specific embodiments of the invention and leveraging the portable device as a wireless handheld game control device with capabilities including position sensing. The device could operate as a controller device in which a housing is held by one hand and, in that state, operating keys and operating switches arranged on an upper surface and lower surface of the portable device housing are operated.

As another example, the system can be used for air mouse for virtual or physical 3D environment. The system can be used for moving and controlling a cursor, object, character or mechanical system in a virtual or physical 3D environment. For instance, the system can be configured to transmit the pointing device coordinates in absolute or relative spherical coordinates or cartesian coordinates to a computing system. According to specific embodiments of the invention, the direction of the pointing device can be used to compute 2D coordinates in an intersecting surface defined by a physical or a virtual surface or screen.

In specific embodiments of the invention, the pointing device can be a control device and the pointing target can be a controllable object. The pointing device can be a remote control for selecting pointing targets in the form of controllable objects, or communication objects generally. Pointing the pointing device at a specific pointing target could form an association between the controllable or communication object and a routing system. The association could then be used to route commands to the currently associated controllable objects or communications from the currently associated communication object. For example, if the object where a controllable object such as a television, commands obtained from a user on the pointing device could be routed to the controllable object while the association was maintained. As another example, if the object were a communication object such as a weather service on a remote server, communications obtained from the remote server could be routed to the pointing device while the association was maintained. In this manner, a user could receive communications from and send command to various objects based on where the pointing device was pointing at any given time.

The object association formed by pointing the pointing device at a given target could also be used to alter a user interface by presenting controls on that interface for the currently associated object. The user interface could be provided on the pointing device. For example, the pointing device could include a touch display, and controls for the currently associated controllable object could be presented on the touch display when the association was formed. When the user pointed the pointing device at a television, the touch display could show a channel and volume control interface for the television. When the user turned the device to point at a light, the touch display could show a brightness control interface for the light.

While the specification has been described in detail with respect to specific embodiments of the invention, it will be appreciated that those skilled in the art, upon attaining an understanding of the foregoing, may readily conceive of alterations to, variations of, and equivalents to these embodiments. For example, although the example of a pointing device comprising two antennas aligned with the pointing axis was used throughout the disclosure, more than two antennas can be aligned with the pointing direction and participate of the angle-of-arrival measurements. Although many examples were given of an UWB system and components, the concepts disclosed herein are equally applied to other radio technologies. These and other modifications and variations to the present invention may be practiced by those skilled in the art, without departing from the scope of the present invention, which is more particularly set forth in the appended claims.

What is claimed is:

1. A device comprising:
a pointing direction;
a set of antennas including a first antenna and a second antenna;
wherein the first antenna and the second antenna are aligned with the pointing direction; and
one or more computer readable media storing instructions which, when executed on the device, cause the device to:
determine a difference between: (i) a signal as received by the first antenna; and (ii) the signal as received by the second antenna; and
determine, using the difference, an angle between: (i) the pointing direction; and (ii) a signal source direction of the signal.

2. The device of claim 1, wherein:
the antennas in the set of antennas are ultra-wide band antennas.

3. The device of claim 1, wherein:
the first antenna and the second antenna are aligned with the pointing direction in that a line connecting a center of the first antenna to a center of the second antenna is parallel with the pointing direction.

4. The device of claim 1, wherein:
the pointing direction is physically delineated by the device.

5. The device of claim 1, wherein:
the set of antennas includes a third antenna; and
the first antenna, the second antenna, and the third antenna are placed on the device in a right triangle configuration.

6. The device of claim 1, wherein:
the signal has a wavelength; and
the first antenna and the second antenna are spaced apart by at least one half of the wavelength.

7. The device of claim 1, wherein:
the device is one of: an air mouse, a smart remote, and a telepointer.

8. The device of claim 1, wherein:
the angle is a pointing angle; and
the one or more computer readable media further store instructions which, when executed on the device, cause the device to:
identify a pointing target based on the pointing angle.

9. The device of claim 1, wherein:
the angle is a pointing angle; and
the one or more computer readable media further store instructions which, when executed on the device, cause the device to:
identify a pointing target based on: (i) the pointing angle, and (ii) a threshold angle; and
wherein the pointing target is identified when the pointing angle is smaller than the threshold angle.

10. The device of claim 1, wherein:
the one or more computer readable media further store instructions which, when executed on the device, cause the device to:
determine a first angular velocity measurement using the angle;
collect sensor data from one of a gravity sensor, a magnetometer, and an inertial measurement unit;
determine a second angular velocity measurement using the sensor data; and
determine, using sensor fusion, a global pointing direction of the device using the first angular velocity measurement and the second angular velocity measurement.

11. The device of claim 10, wherein:
the sensor fusion is conducted using a Kalman filter.

12. A system comprising:
a portable device having a pointing direction and a set of antennas including a first antenna and a second antenna, wherein the set of antennas is aligned with the pointing direction;
a third antenna associated with a pointing target; and
one or more computer readable media storing instructions which, when executed by the system, cause the system to:
transmit a signal using the third antenna;
determine a difference between: (i) a signal as received by the first antenna; and (ii) the signal as received by the second antenna; and
determine, using the difference, an angle between: (i) the pointing direction; and (ii) a line between the pointing target and the portable device.

13. The system of claim 12, further comprising:
an array of antennas which includes the third antenna;
wherein the one or more computer readable media further store instructions which, when executed by the system, cause the system to:
transmit a set of signals using the array of antennas;
determine a set of differences between: (i) the signals in the set of signals as received by the first antenna; and (ii) the signals in the set of signals as received by the second antenna; and
determine, using the set of differences, a pose and location of the portable device.

14. The system of claim 12, further comprising:
the first antenna, the second antenna, and the third antenna are all ultra-wide band antennas.

15. The system of claim 12, further comprising:
at least two additional antennas associated with the pointing target;
wherein the one or more computer readable media further store instructions which, when executed by the system, cause the system to:
determine at least two additional angles for at least two additional signals transmitted by the at least two additional antennas;
wherein each angle defines a pointing cone associated with the pointing target; and
wherein the pointing direction of the portable device is determined by an intersection of the pointing cones.

16. The system of claim 12, wherein:
the set of antennas is aligned with the pointing direction in that a line that passes through the center of each antenna in the set of antennas is parallel with the pointing direction.

17. The system of claim 12, wherein:
the pointing direction is physically delineated by the portable device.

18. The system of claim 12, wherein:
the set of antennas includes a fourth antenna; and
the first antenna, the second antenna, and the fourth antenna are placed on the portable device in a right triangle configuration.

19. The system of claim 12, wherein:
the signal has a wavelength; and
the first antenna and the second antenna are spaced apart by at least one half of the wavelength.

20. The system of claim 12, wherein:
the portable device is one of: an air mouse, a smart remote, and a telepointer.

21. The system of claim 12, wherein:
the angle is a pointing angle; and
the one or more computer readable media further store instructions which, when executed by the system, cause the system to:
identify the pointing target based on the pointing angle.

22. The system of claim 12, wherein:
the angle is a pointing angle; and
the one or more computer readable media further store instructions which, when executed by the system, cause the system to:
identify the pointing target based on: (i) the pointing angle, and (ii) a threshold angle; and
wherein the pointing target is identified when the pointing angle is smaller than the threshold angle.

23. The system of claim 12, wherein:
the pointing target is a display; and
the third antenna is centered on the display.

24. The system of claim 12, wherein the one or more computer readable media further store instructions which, when executed by the system, cause the system to:
determine a first angular velocity measurement using the angle;
collect sensor data from one of a gravity sensor, a magnetometer, and an inertial measurement unit;
determine a second angular velocity measurement using the sensor data; and
determine, using sensor fusion, a global pointing direction of the portable device using the first angular velocity measurement and the second angular velocity measurement.

25. The system of claim 24, wherein:
the sensor fusion is conducted using a Kalman filter.

26. A method, in which each step is computer-implemented, comprising:
obtaining a first sample of a signal on a first antenna and a second sample of the signal on a second antenna, wherein the first antenna and the second antenna are in a set of antennas on a portable device, and wherein the set of antennas are aligned with a pointing direction of the portable device;
determining, using the first sample and the second sample, a difference between: (i) a signal as received by the first antenna; and (ii) the signal as received by the second antenna; and
determining, using the difference, an angle between: (i) the pointing direction; and (ii) a line between a target point and the portable device.

27. The method of claim 26, further comprising:
identifying a pointing target based on the angle.

28. The method of claim 26, further comprising:
identifying a pointing target based on: (i) the angle, and (ii) a threshold angle; and
wherein the pointing target is identified when the angle is smaller than the threshold angle.

29. The method of claim 26, further comprising:
determining a first angular velocity measurement using the angle;
collecting sensor data from one of a gravity sensor, a magnetometer, and an inertial measurement unit;
determining a second angular velocity measurement using the sensor data; and
determining, using sensor fusion, a global pointing direction of the portable device using the first angular velocity measurement and the second angular velocity measurement.

30. The method of claim 26, further comprising:
transmitting a set of signals using an array of antennas which includes a third antenna, wherein the third antenna is associated with the target point;
determining a set of differences between: (i) a first set of phases of the signals in the set of signals as received by the first antenna; and (ii) a second set of phases of the signals in the set of signals as received by the second antenna; and
determining, using the set of differences, a pose and location of the portable device.
